(19) United States
(12) Patent Application Publication
(10) Pub. No.: US 2025/0145526 A1
(43) Pub. Date: May 8, 2025

(54) BIOFIBER COMPOSITE AND METHOD OF MAKING A BIOFIBER COMPOSITE

(71) Applicant: Jobrani Holdco Ltd., Edmonton (CA)

(72) Inventor: Parisa HAJI ABDULRAZAGH, Edmonton (CA)

(21) Appl. No.: 18/610,938

(22) Filed: Mar. 20, 2024

(30) Foreign Application Priority Data
Nov. 7, 2023 (CA) 3 218 996

(51) Int. Cl. C04B 18/12; B33Y 10/00; B33Y 70/10; B33Y 80/00; C04B 16/06; C04B 18/24; C04B 18/30; E04G 21/04

(52) U.S. Cl. CPC C04B 18/12; B33Y 70/10; B33Y 80/00; C04B 16/0675; C04B 18/248; C04B 18/30; E04G 21/04; B33Y 10/00

(57) ABSTRACT

A biofiber composite and method of use are provided. The biofiber composite is made up of 75% to 85% by weight of a regolith and 25% to 15% by weight of a mortar. The mortar is 85% to 98% by weight of a liquid, 14% to 1% by weight of an amylopectin, hemp fibers and protein filaments, and 0.3% to 1% by weight of a keratin rich modifier.

### FIELD OF THE DISCLOSURE

The present application relates generally to a biofiber composite and a method of making a biofiber composite.

### BACKGROUND

This section provides background information to facilitate a better understanding of the various aspects of the invention. It should be understood that the statements in this section of this document are to be read in this light, and not as admissions of prior art.

### BRIEF SUMMARY

There is provided a biofiber composite that is made of a regolith and a mortar. 75% to 85% by weight of the biofiber composite is regolith, 25% to 15% by weight of the biofiber composite is mortar. The mortar is made of 85% to 98% by weight of a liquid, 14% to 1% by weight of an amylopectin, hemp fibers and protein filaments, and 0.3% to 1% by weight of a keratin rich modifier.

In one embodiment, the liquid of the mortar is a liquid metabolic waste. The liquid metabolic waste may be urine.

In one embodiment, the protein filaments are hair.

In one embodiment, the mortar is made up of 90% to 98% by weight of liquid, 9.4% to 1.4% by weight of amylopectin, hemp fibers and protein filaments, and 0.6% keratin rich modifier.

In another embodiment, the mortar is made up of 85% to 95% by weight of liquid, 14.4% to 4.4% by weight of amylopectin, hemp fibers and protein filaments, and 0.6% keratin rich modifier.

In one embodiment, the regolith has a size of 10 mm in diameter or less.

There is also provided a three-dimensional printed panel that is made using the biofiber composite as the printing material.

In one embodiment, the three-dimensional printed panel has a corrugated shape.

In one embodiment, a first three-dimensional printed panel is attachable to a second three-dimensional printed panel by a dovetail joint.

There is also provided a structure that is made of a plurality of three-dimensional printed panels that are printed using the biofiber composite as the printing material.

In one embodiment, the structure has a semi-arch tunnel shape.

There is also provided a method of creating a biofiber composite. A regolith of various sizes is provided and sorted with a sieve such that a regolith having a size of 10 mm in diameter or less is collected. The regolith having a size of 10 mm in diameter or less is blended with a mortar to create the biofiber composite. The biofiber composite is made of 75% to 85% by weight of the regolith and 25% to 15% by weight of a mortar.

In one embodiment, the regolith of various sizes is transported from a source to a sieve using a conveyer.

In one embodiment, the sieve is a vibratory sieve.

In one embodiment, the mortar is made up of 85% to 98% by weight of a liquid, 14% to 1% by weight of an amylopectin, hemp fibers and protein filaments, and 0.3% to 1% by weight of a keratin rich modifier.

In one embodiment, the mortar is made up of 90% to 98% by weight of liquid, 9.4% to 1.4% by weight of amylopectin, hemp fibers and protein filaments, and 0.6% keratin rich modifier.

In one embodiment, the mortar is made up of 85% to 95% by weight of liquid, 14.4% to 4.4% by weight of amylopectin, hemp fibers and protein filaments, and 0.6% keratin rich modifier.

In one embodiment, the blending of the regolith and mortar occurs in a centrifugal blender. The centrifugal blender has a regolith inlet, a mortar inlet, a biofiber composite outlet, and at least one impeller. The at least one impeller forcing the biofiber composite out of the biofiber composite outlet.

In one embodiment, a centrifugal printer for using the biofiber composite as a three dimensional printing material is provided. The centrifugal printer has a biofiber composite inlet, a printing tip, and at least one printer impeller. The at least one printer impeller forcing the biofiber composite out of the tip of the centrifugal printer.

### BRIEF DESCRIPTION OF THE DRAWINGS

These and other features will become more apparent from the following description in which references are made to the following drawings, in which numerical references denote like parts. The drawings are for the purpose of illustration only and are not intended to in any way limit the scope of the invention to the particular embodiments shown.

FIG. 1 is a perspective view of a panel being printed.

FIG. 2 is a front plan view, partially in section, of a structure made from printed panels.

FIG. 3 is a top plan view, partially in section, of a printed panel.

FIG. 4 is a front elevation view of a plurality of printed panels having a first variation of dovetail joints.

FIG. 5 is a front elevation view of a plurality of printed panels having a second variation of dovetail joints.

FIG. 6 is a front elevation view of a plurality of printed panels having a third variation of dovetail joints.

FIG. 7 is a perspective view of a portion of a printed panel with a trapezoidal male dovetail joint.

FIG. 8 is a perspective view, partially in section, of a portion of a printed panel with a trapezoidal female dovetail joint corresponding to the male dovetail joint of FIG. 7.

FIG. 9 is a perspective view of a portion of a printed panel with a sinusoidal male dovetail joint.

FIG. 10 is a perspective view, partially in section, of a portion of a printed panel with a sinusoidal female dovetail joint corresponding to the male dovetail joint of FIG. 9.

FIG. 11 is a perspective view of a structure created using the printed panels.

FIG. 12 is a top plan view, in section, of an interior of the structure created using the printed panels.

FIG. 13 is a perspective view of a colony created using a plurality of structures and attached tunnels created using the printed panels.

FIG. 14 is a side elevation view of a production line for the biofiber composite.

FIG. 15 is a side elevation view of mixer and centrifugal three-dimensional printer used to create the biofiber composite and print panels.

FIG. 16 is a side elevation view of a first step in building a structure.

FIG. 17 is a side elevation view of the bottom of the structure being built.

FIG. 18 is a side elevation view of the sides of the structure being built.

FIG. 19 is a side elevation view of the structure being completed.

FIG. 20 is a side elevation view of the structure being backfilled.

FIG. 21 is a side elevation view of the completed backfilled structure.

### DETAILED DESCRIPTION OF THE PREFERRED EMBODIMENTS

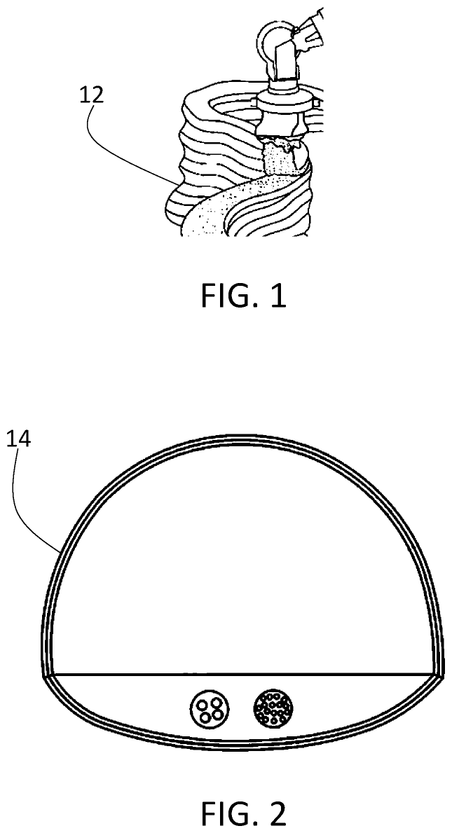

A biofiber composite, method of making a biofiber composite, and method of use for a biofiber composite will now be described with reference to FIG. 1 through FIG. 21.

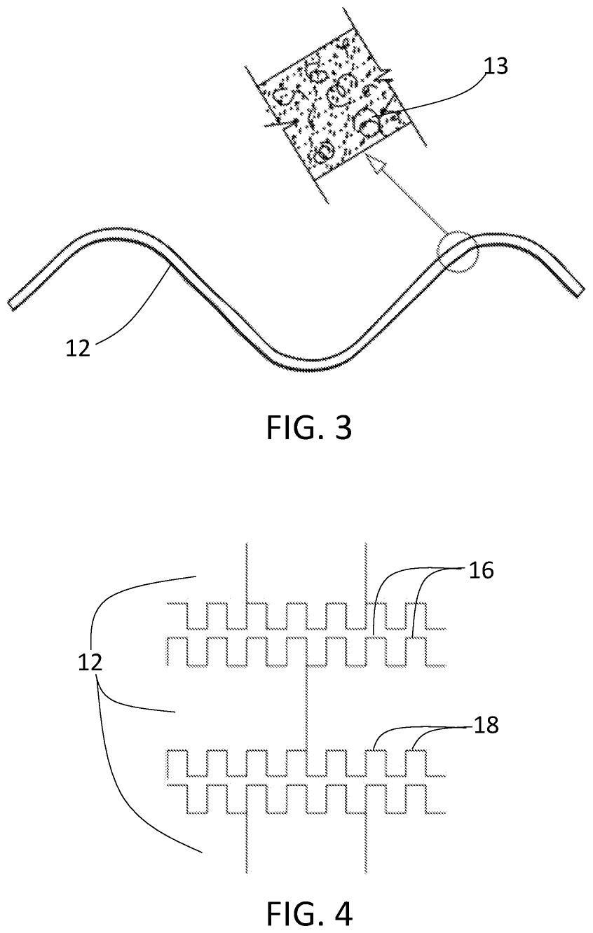

A biofiber composite made up of 75% to 85% by weight of a regolith 11, shown in FIG. 14, and 25% to 15% by weight of a mortar may be created in a wide range of environments. The use of in-situ local regolith allows the biofiber composite to be made on site and may be useful in protecting environments from outside contaminants. It will be understood by a person skilled in the art that regolith is the loose rock, dust, and other related materials and it is present on Earth, the Moon, Mars, some asteroids, and other terrestrial planets and moons. By using regolith 11, there is less damage to the environment as mining is not likely to be needed. While any size of regolith 11 may be used, it is preferred that regolith 11 have a size of 10 mm in diameter or less. The mortar is made up of 85% to 98% by weight of a liquid, 14% to 1% by weight of an amylopectin, hemp fibers and protein filaments 13, shown in FIG. 3, and 0.3% to 1% by weight of a keratin rich modifier. Many different types of plants, including the glass family of Poaceae, are keratin rich and can be sourced from nature, nurseries, and/or labs. The liquid in the mortar may be water, liquid metabolic waste such as urine, or any other suitable liquid known to a person skilled in the art. Liquid metabolic waste may be useful as a liquid when access to water or other liquids are limited or the transportation of liquid to a location is overly burdensome. Protein filaments can include hair, or any other suitable protein filament known to a person skilled in the art. The use of these types of materials can allow for the biofiber composite to be made without the requirement of transporting materials from other locations.

Mortar may be made of different percentages of liquid, amylopectin, hemp fibers and protein filaments 13, and keratin rich modifier. In one version the mortar is made of 90% to 98% by weight of liquid, 9.4% to 1.4% by weight of amylopectin, hemp fibers and protein filaments 13, and 0.6% keratin rich modifier. This version of the mortar may be useful when the panels need to be more rigid. In a second version, the mortar is made of 85% to 95% by weight of liquid, 11.4% to 4.4% by weight of amylopectin, hemp fibers and protein filaments 13, and 0.6% keratin rich modifier. This version of the mortar may be useful when the panels need to be more flexible.

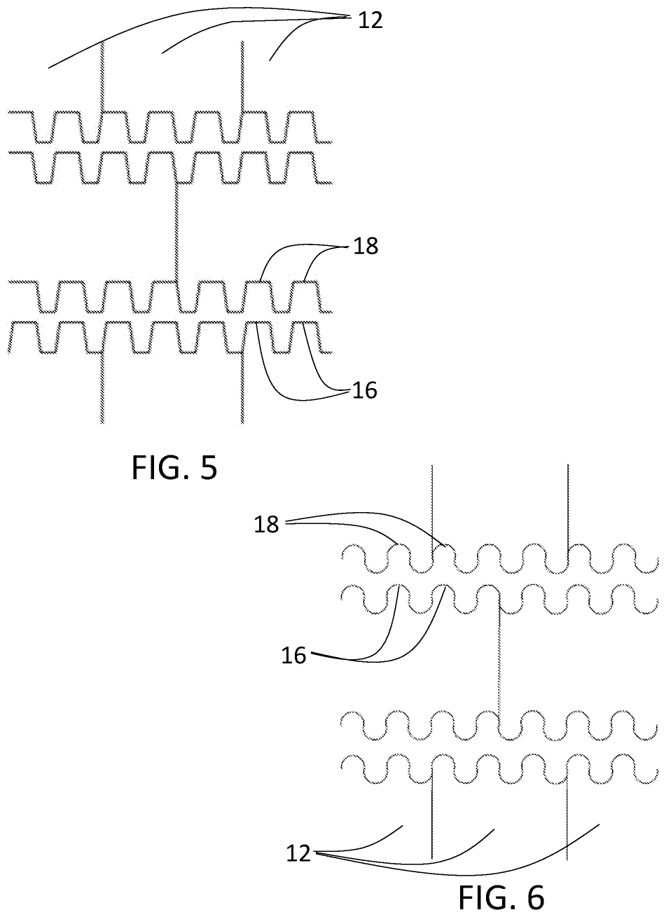

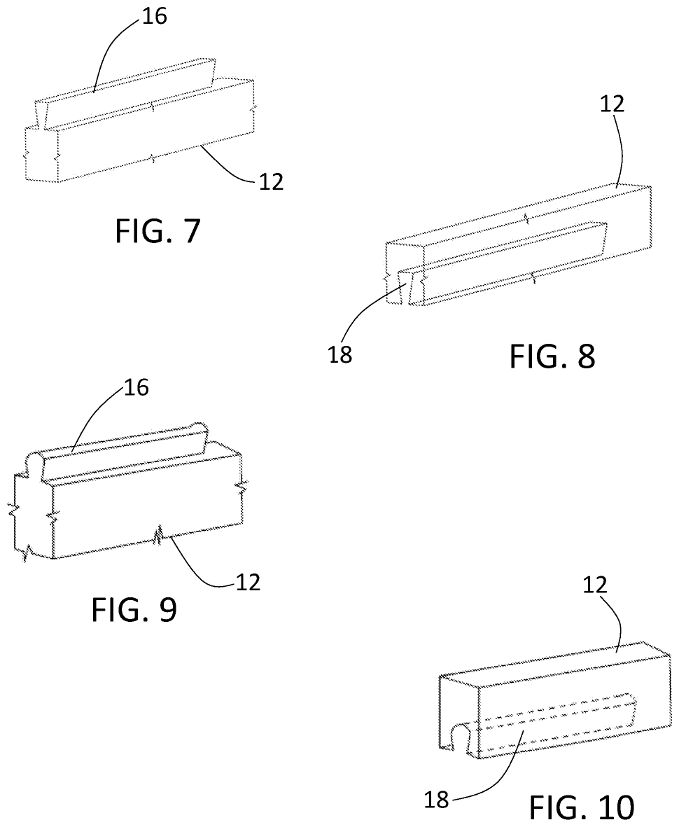

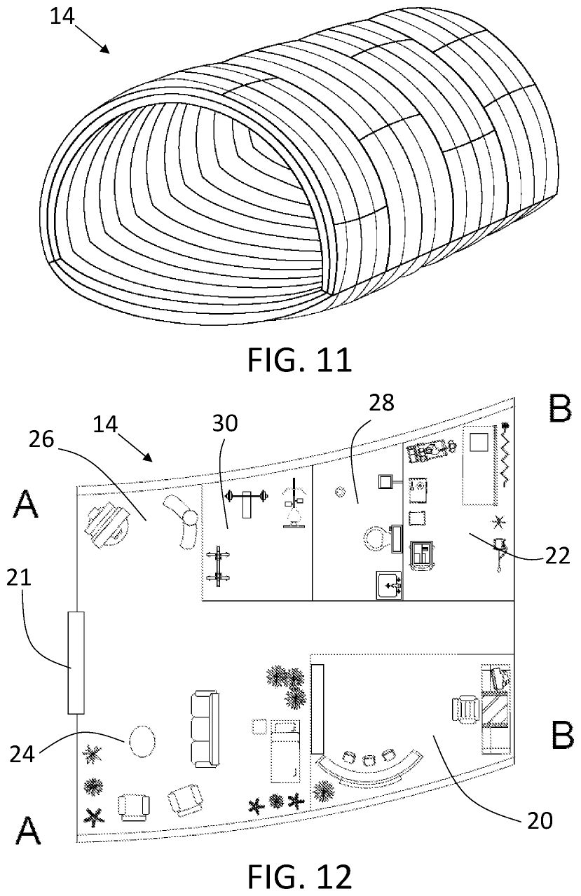

Referring to FIG. 1, a three-dimensional printed panel 12 is printed using the biofiber composite described above as the printing material. Referring to FIG. 3, three-dimensional printed panel 12 may have a corrugated shape that provides greater strength and stability when used in the building of structures 14, shown in FIG. 2, and allows for thinner three-dimensional printed panels 12 to be made. An additional benefit of printing a thinner three-dimensional printed panel 12 is that less heat will be generated during the printing process when compared to thicker printed panels or entire structures. The corrugated shape may be up to ten times stronger than a flat sheet of substantially the same thickness. Referring to FIG. 4 through FIG. 6, when used to build structures 14, adjacent three-dimensional panels may be attached together through the use of dovetail joints. Dovetail joints allow for adjacent three-dimensional panels to be rapidly assembled to create structures for a wide range of uses including, but not limited to, extraterrestrial habitats, extreme event evacuation shelters, and housing and laboratory stations in remote locations such as arctics and deserts. One benefit of dovetail joints is that it eliminates the need for holes and bolts which can create weak points in structure. Dovetail joints have a male portion 16 and a corresponding female portion 18. As can be seen in the present embodiments, the shape of male portion 16 and female portion 18 may vary. In the embodiment shown in FIG. 4, male portion 16 and female portion 18 have corresponding rectangular shapes. In the embodiment shown in FIG. 5, FIG. 7, and FIG. 8, male portion 16 and female portion 18 have corresponding trapezoidal shapes. In the embodiment shown in FIG. 6, FIG. 9, and FIG. 10, male portion 16 and female portion 18 have corresponding sinusoidal shapes. It will be understood by a person skilled in the art that different shapes may be used. Different shapes may be used for different joints between panels to help with resistance to applied loads from different directions.

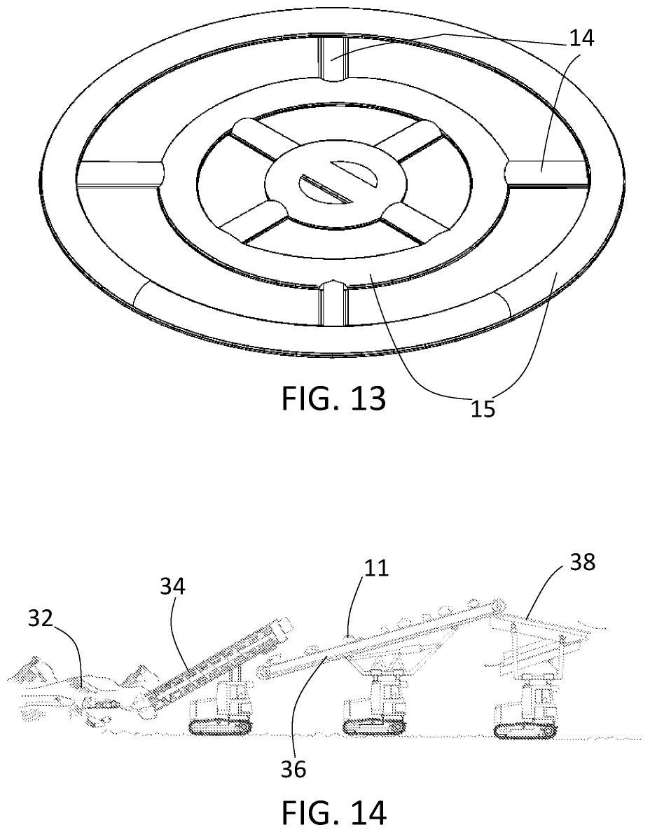

Structures 14 created using three-dimensional printed panels may be constructed by hand or through the use of automated machines or robots. Remote supervision of construction and the status of machines and robots can be used to ensure proper construction. In the embodiments shown in FIG. 11, structure 14 has a semi-arch tunnel shape with limited to no flat sides, sharp edges, or changes to the profile. This can help to limit stress that can occur on flat sharp edges during storms and extreme temperatures. In the embodiment shown in FIG. 13, a network of structures 14 and tunnels 15 may be used to create a colony or grouping of structures 14. Each structure 14 in the colony can be set up the same or each structure may serve a different purpose. As an example only, in the embodiment shown in FIG. 12, structure 14 is divided into a number of different areas such as a laboratory 20, utility room 22, living area 24, entertainment area 26, bathroom 28, and gym 30. This type of set up may be beneficial when structure will be in use for a longer period of time. It will be understood by a person skilled in the art that different items and areas may be placed within structure 14 depending upon the needs of the user. Entrances 21 may be used to separate spaces from each other and allow for more privacy. Colony can allow for safe movement of people between structures when it is unsafe to be out in the elements.

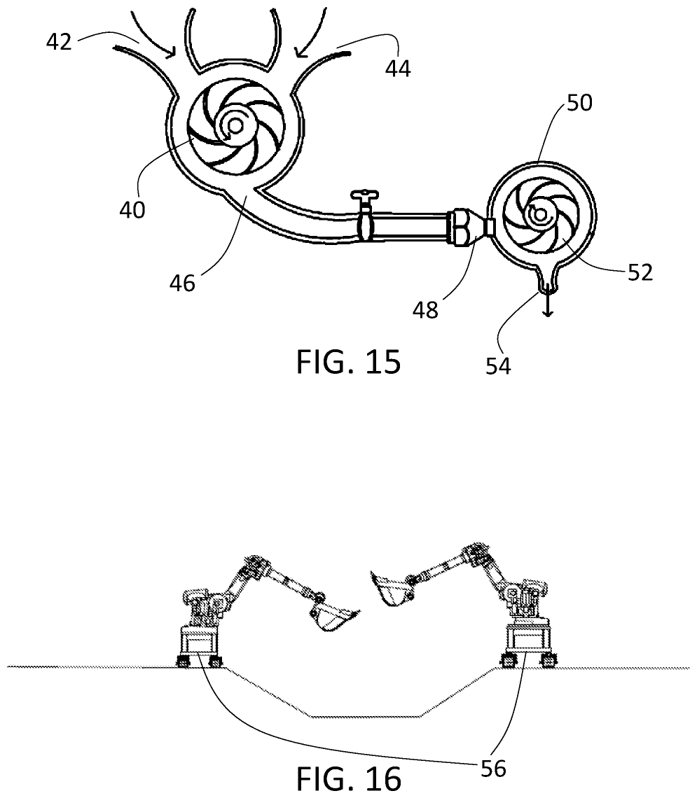

In the embodiment shown in FIG. 14, regolith 11 is collected from a source 32. In the embodiment shown, a screw conveyer 34 and a belt conveyer 36 are utilized to transport regolith 11 to a vibratory sieve 38. Vibratory sieve 38 is used to sort regolith 11 such that regolith 11 having a size of 10 mm in diameter or less is collected for use. It will be understood by a person skilled in the art that regolith 11 that is too large may be crushed or otherwise worked to reduce the size to the appropriate size of 10 mm in diameter or less. Referring to FIG. 15, regolith 11 having a size of 10 mm in diameter or less is directed to a blender 40 which has a regolith blender inlet 42 and a mortar blender inlet 44 through which mortar is directed. Regolith and mortar are blended together to create biofiber composite. Biofiber composite exits blender 40 through outlet 46 where it travels through a nozzle 48 into a centrifugal three dimensional printer 50. Centrifugal three-dimensional printer 50 has an impeller 52 to keep biofiber composite in motion and a tip 54 through which three-dimensional printing may occur to create three-dimensional printed panel 12. In blender 40, rotation of impellers 41 mix regolith and mortar together. This creates a suction in outlet 46 which facilitates the flow of biofiber composite. Rotation of impeller 52 in three dimensional printer 50 creates a negative pressure behind impellers 52 and forces biofiber composite to tip 54. This allows for printing in conditions where creating pressure to expel biofiber composite, such as a low/no gravity situations, is challenging or impossible.

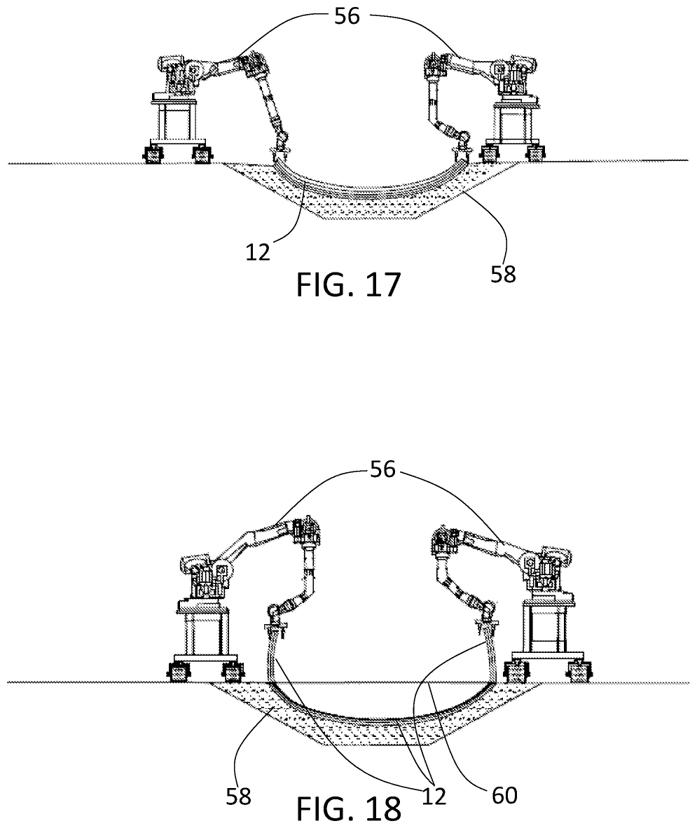

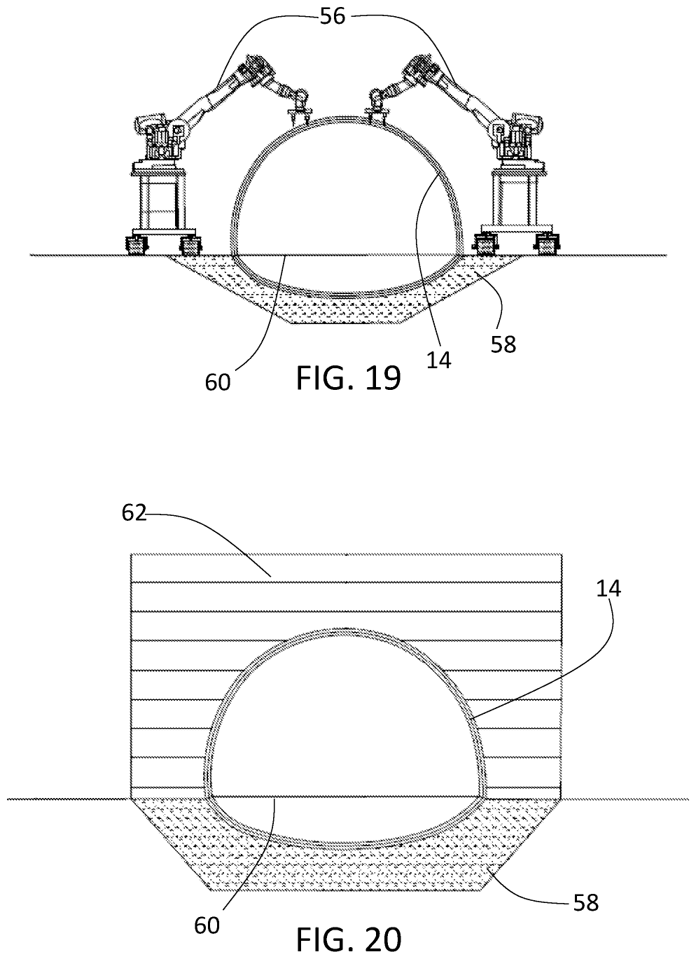

Referring to FIG. 16, when building structure 14, shown in FIG. 11, it may be beneficial to excavate a space at the location of structure. This may be done by hand, with heavy machinery, or by any other suitable mechanism known to a person skilled in the art such as automated, semi-automated, or remote controlled vehicles and robots 56. Referring to FIG. 17, after excavation, a fill 58 may be inserted into excavated area. Fill 58 is preferably a mixture of regolith having a maximum particle size of 10 mm and mortar, but it will be understood by a person skilled in the art that any suitable material may be used. Fill 58 provides additional insulation and helps to prevent damage in the event of settling of material. After fill 58 has been installed, panels 12 are positioned on fill 58. The number of panels 12 that are needed will depend on the size of panels 12 and the size of structure 14 being created. As can be seen, panels 12 are inverted such that they create a concave shape. Referring to FIG. 18, after panels 12 have been positioned on the bottom of structure 14, a floor slab 60 may be installed. Floor slab 60 is preferred as it creates an air pocket which can assist in insulation and floor slab 60 creates a more substantial floor than fill. Electrical cables, pipes, internet network cables, ventilation, and other types of pipes/cables can be positioned under floor slab 60. Additional three-dimensional printed panels 12 are provided to continue building structure 14. Referring to FIG. 19, structure 14 is completed.

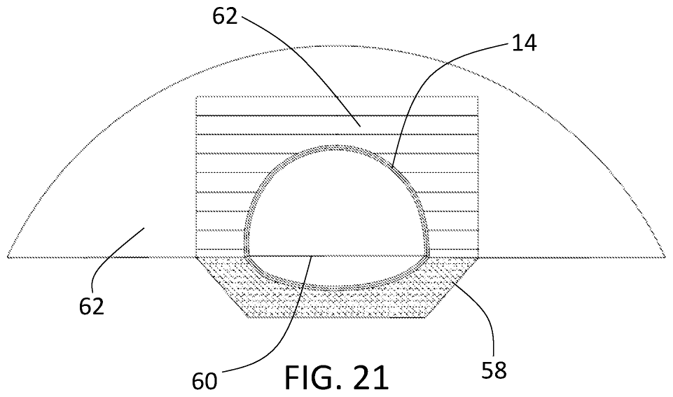

Referring to FIG. 20 and FIG. 21, once structure 14 is built, it may be beneficial to backfill structure under fill 58. Fill 58 may include regolith 11, biofiber composite, fill 58, bagged materials or any other suitable material known to a person skilled in the art. In one embodiment, fill 58 may be made of 80% to 90% regolith having a maximum particle size of 10 mm, with the remaining 10% to 20% being mortar. The use of biofibers and modifiers can be used if available. This can provide insulation and protection from the elements, including potential radiation, extreme weather, and more. Structure is preferably air-tight at four to twenty pounds per square inch absolute (psia). The amount of fill 58 used may vary. In one embodiment, a minimum of one meter of fill 58 is placed on and around structure 14. It will be understood by a person skilled in the art that different amounts of fill 58 may be beneficial in different scenarios. The use of extra fill 58 may improve protection from the elements, including radiation, and improve longevity of structure 14.

Any use herein of any terms describing an interaction between elements is not meant to limit the interaction to direct interaction between the subject elements, and may also include indirect interaction between the elements such as through secondary or intermediary structure unless specifically stated otherwise.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent that changes may be made to the illustrative embodiments, while falling within the scope of the invention. As such, the scope of the following claims should not be limited by the preferred embodiments set forth in the examples and drawings described above, but should be given the broadest interpretation consistent with the description as a whole.

What is claimed is:

1. A biofiber composite comprising:
75% to 85% by weight of a regolith;
25% to 15% by weight of a mortar, the mortar comprising of 85% to 98% by weight of a liquid, 14% to 1% by weight of an amylopectin, hemp fibers and protein filaments, and 0.3% to 1% by weight of a keratin rich modifier.

2. The biofiber composite of claim 1 wherein the liquid is a liquid metabolic waste.

3. The biofiber composite of claim 2 wherein the liquid metabolic waste is urine.

4. The biofiber composite of claim 1 where the protein filaments are hair.

5. The biofiber composite of claim 1 wherein there the mortar comprises 90% to 98% by weight of liquid, 9.4% to 1.4% by weight of amylopectin, hemp fibers and protein filaments, and 0.6% keratin rich modifier.

6. The biofiber composite of claim 1 wherein the mortar comprises 85% to 95% by weight of liquid, 14.4% to 4.4% by weight of amylopectin, hemp fibers and protein filaments, and 0.6% keratin rich modifier.

7. The biofiber composite of claim 1 wherein the regolith has a size of 10 mm in diameter or less.

8. A three-dimensional printed panel where a printing material is the biofiber composite of claim 1.

9. The three-dimensional printed panel of claim 8 wherein the three dimensional printed panel has a corrugated shape.

10. The three-dimensional printed panel of claim 8 wherein a first three-dimensional printed panel is attachable to a second three-dimensional printed panel by a dovetail joint.

11. A structure being made of a plurality of three-dimensional printed panels of claim 8.

12. The structure of claim 11 wherein the structure has a semi-arch tunnel shape.

13. A method of creating a biofiber composite comprising the steps of:
providing a regolith of various sizes;
sorting the regolith of various sizes with a sieve such that a regolith having a size of 10 mm in diameter or less is collected; and
blending the regolith having a size of 10 mm in diameter or less with a mortar to create the biofiber composite, the biofiber composite being comprised of 75% to 85% by weight of the regolith and 25% to 15% by weight of a mortar.

14. The method of claim 13 further comprising the step of transporting the regolith of various sizes from a source to the sieve using a conveyor.

15. The method of claim 13 wherein the sieve is a vibratory sieve.

16. The method of claim 13 wherein the mortar is comprised of 85% to 98% by weight of a liquid, 14% to 1% by weight of an amylopectin, hemp fibers and protein filaments, and 0.3% to 1% by weight of a keratin rich modifier.

17. The method of claim 16 wherein the mortar is comprised of 90% to 98% by weight of liquid, 9.4% to 1.4% by weight of amylopectin, hemp fibers and protein filaments, and 0.6% keratin rich modifier.

18. The method of claim 16 wherein the mortar is comprised of 85% to 95% by weight of liquid, 14.4% to 4.4% by weight of amylopectin, hemp fibers and protein filaments, and 0.6% keratin rich modifier.

19. The method of claim 13 wherein blending of the regolith and mortar occurs in a centrifugal blender, the centrifugal blender having a regolith inlet, a mortar inlet, a biofiber composite outlet, and at least one impeller, the at least one impeller forcing the biofiber composite out of the biofiber composite outlet.

20. The method of claim 19 further comprising a centrifugal printer for using the biofiber composite as a three dimensional printing material, the centrifugal printer having a biofiber composite inlet, a printing tip, and at least one printer impeller, the at least one printer impeller forcing the biofiber composite out of the tip of the centrifugal printer.
